(19) United States
(12) Patent Application Publication
(10) Pub. No.: US 2026/0072784 A1
(43) Pub. Date: Mar. 12, 2026

(54) Apparatus, Device, and Method for Handling Defective Memory Hardware Locations

(71) Applicants: Sean DARDIS, Forest Grove, OR (US); Pawan CHHABRA, Bangalore (IN); Miraben PATEL, Folsom, CA (US); Ingrid MURPHY, San Jose, CA (US); Kamraan NASIM, Folsom, CA (US); Marcus WINSTON, Aloha, OR (US); Sreeja MENON, Delhi (IN); Pratap PRASAD, Santa Clara, CA (US); Marian CRETU, Santa Clara, CA (US); Biju Neerthattil SUDHAKARAN, Bangalore (IN); Anthony GIARDINA, Colfax, CA (US); Joaquin ROMERA, San Diego, CA (US)

(72) Inventors: Sean DARDIS, Forest Grove, OR (US); Pawan CHHABRA, Bangalore (IN); Miraben PATEL, Folsom, CA (US); Ingrid MURPHY, San Jose, CA (US); Kamraan NASIM, Folsom, CA (US); Marcus WINSTON, Aloha, OR (US); Sreeja MENON, Delhi (IN); Pratap PRASAD, Santa Clara, CA (US); Marian CRETU, Santa Clara, CA (US); Biju Neerthattil SUDHAKARAN, Bangalore (IN); Anthony GIARDINA, Colfax, CA (US); Joaquin ROMERA, San Diego, CA (US)

(21) Appl. No.: 19/389,172

(22) Filed: Nov. 14, 2025

(51) Int. Cl. G06F 11/10; G06F 13/42

(52) U.S. Cl. CPC G06F 11/1016; G06F 11/1076; G06F 13/4221

(57) ABSTRACT

Provided is an apparatus, a device, a method, a computer program, and a non-transitory, computer-readable medium comprising a program code for a computer system, as well as a computer system. An apparatus (10) for a computer system (100) comprises memory circuitry (11) for storing information identifying at least one defective memory hardware location, and one or more hardware address determination circuitries (12, 13) configured to determine a mapping between a physical memory address and a hardware location address of corresponding memory (101, 102), wherein the one or more hardware address determination circuitries are configured to adapt the mapping at run-time upon obtaining updated information identifying at least one defective memory hardware location.

### BACKGROUND

Modern operating systems provide mechanisms to offline or isolate specific memory pages to handle hardware errors and prevent system crashes. For example, the Linux operating system offers the memory failure handling infrastructure, which can be triggered through the madvise() system call or via hardware-detected errors that generate machine check exceptions. When a page is identified as faulty, the OS can mark it as poisoned in the page tables, prevent future allocations from using it, and migrate data to healthy pages if possible. The /sys/devices/system/memory/ interface allows administrators to manually offline memory sections, while the kernel maintains bad page lists to persistently track defective pages across reboots. These features are particularly important for servers with large memory configurations where complete system restarts due to isolated memory errors would be costly, enabling graceful degradation instead of catastrophic failure.

The existing memory page offline feature is a mechanism that allows software to handle device memory errors by preventing the allocation of memory addresses (software pages) that are impacted by bad memory, ensuring that a computing device can remain operational even when a memory device error occurs. This feature is used for maintaining system stability, reducing downtime, and keeping a device usable for running workloads. This approach has a limitation of needing to remove more address space (in software pages) than real hardware addresses are impacted by a bad memory location. In particular, the resulting amount may be a ratio (determined by hashing) of how many software pages end up in a grouped hardware address, such as a row or column. Additionally, the software may have to retrieve information from the device about which bad pages need to be offlined or retired, track these pages, and maintain a list of bad software pages across the device memory.

### BRIEF DESCRIPTION OF THE FIGURES

Some examples of apparatuses and/or methods will be described in the following by way of example only, and with reference to the accompanying figures, in which:

FIG. 1a shows a schematic diagram of an apparatus or device for handling defective memory hardware locations, and of a computer system comprising such an apparatus or device;

FIG. 1b shows a flowchart of a method for handling defective memory hardware locations;

FIG. 2 shows a schematic diagram of an address path to hardware;

FIG. 3 shows a schematic diagram of a split hashing view; and

FIG. 4 shows a block diagram of an example computer system.

### DETAILED DESCRIPTION

Some examples are now described in more detail with reference to the enclosed figures. However, other possible examples are not limited to the features of these embodiments that are described in detail. Other examples may include modifications of the features, as well as equivalents and alternatives to the features. Furthermore, the terminology used herein to describe certain examples should not be restrictive of further possible examples.

Throughout the description of the figures, same or similar reference numerals refer to the same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e., only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an”, and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components, and/or a group thereof, but do not exclude the presence or addition of one or more other features, integers, steps, operations, processes, elements, components, and/or a group thereof.

In the following description, specific details are set forth, but examples of the technologies described herein may be practiced without these specific details. Well-known circuits, structures, and techniques have not been shown in detail to avoid obscuring an understanding of this description. “An example/example,” “various examples/examples,” “some examples/examples,” and the like may include features, structures, or characteristics, but not every example necessarily includes the particular features, structures, or characteristics.

Some examples may have some, all, or none of the features described for other examples. “First,” “second,” “third,” and the like describe a common element and indicate different instances of like elements being referred to. Such adjectives do not imply that the element item so described must be in a given sequence, either temporally or spatially, in ranking, or any other manner. “Connected” may indicate elements are in direct physical or electrical contact with each other, and “coupled” may indicate elements co-operate or interact with each other, but they may or may not be in direct physical or electrical contact.

As used herein, the terms “operating”, “executing”, or “running” as they pertain to software or firmware in relation to a system, device, platform, or resource are used interchangeably and can refer to software or firmware stored in one or more computer-readable storage media accessible by the system, device, platform, or resource, even though the instructions contained in the software or firmware are not actively being executed by the system, device, platform, or resource.

The description may use the phrases “in an example/example,” “in examples/examples,” “in some examples/examples,” and/or “in various examples/examples,” each of which may refer to one or more of the same or different examples. Furthermore, the terms “comprising,” “including,” “having,” and the like, as used with respect to examples of the present disclosure, are synonymous.

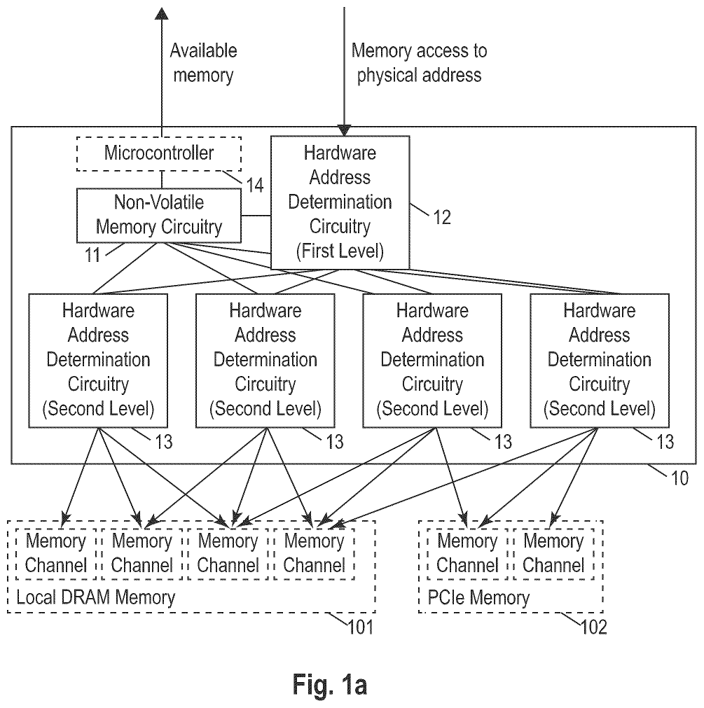

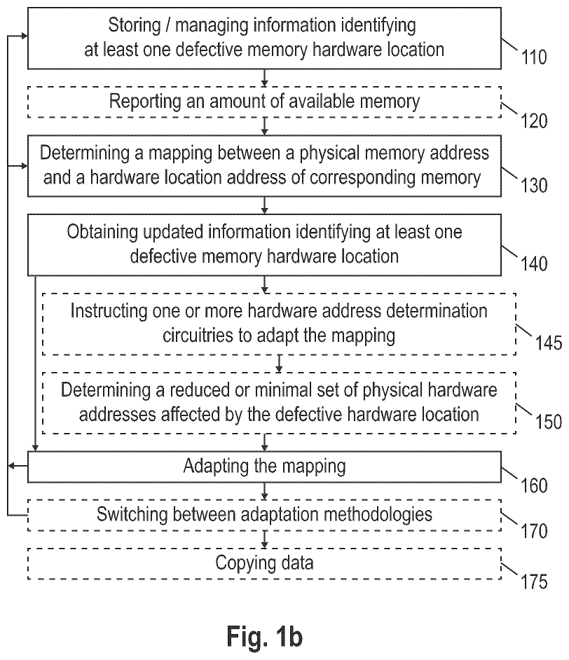

FIG. 1a shows a schematic diagram of an apparatus 10 or device 10 for handling defective memory hardware locations, and of a computer system 100 comprising such an apparatus 10 or device 10. The apparatus 10 comprises circuitry to provide the functionality of the apparatus 10. For example, the circuitry of the apparatus 10 may be configured to provide its functionality. For example, as shown in FIG. 1a, the apparatus 10 comprises one or more hardware address determination circuitries 12, 13 (e.g., a first-or higher-level hardware address determination circuitry 12 and one or more second-or lower-level hardware address determination circuitries 13), which perform a mapping between addresses in the physical address space of the computer system and the “actual” hardware addresses of the local or remote (Dynamic Random Access Memory, DRAM) memory 101, 102, e.g., performing memory striping and hardware-assisted page offlining. In addition, the apparatus 10 comprises a non-volatile memory circuitry 11, which is used to store information identifying at least one defective memory hardware location. Optionally, the apparatus 10 may comprise a microcontroller 14 that manages (e.g., updates, verifies) the stored information identifying at least one defective memory hardware location, and which reports the amount of available memory based on the stored information identifying at least one defective memory hardware location. The non-volatile memory circuitry 11 is coupled with the microcontroller 14, which may be used to manage the stored information, and with the hardware address determination circuitries 12, 13, which use the stored information to determine the hardware addresses of the memory. For example, the hardware address determination circuitries 12, 13 may be controlled (e.g., programmed) by the microcontroller 14 to perform their respective tasks, i.e., to determine and adapt the mapping between addresses of the physical address space and the hardware addresses. Likewise, the device 10 may comprise means for providing the functionality of the device 10. For example, the means may be configured to provide the functionality of the device 10. The components of the device 10 are defined as component means, which may correspond to, or be implemented by, the respective structural components of the apparatus 10. For example, the device 10 comprises means for storing information 11, which may be implemented by the non-volatile memory circuitry 11, one or more hardware address determination means, which may be implemented by the one or more hardware address determination circuitries 12, 13, and the microcontroller 14. In general, some functionality of the apparatus 10 or device 10 may be defined by software, i.e., machine-readable instructions stored in a memory, such as non-volatile memory circuitry 11. For example, the functionality of the microcontroller 14 may be defined by software (e.g., a system firmware, such as a UEFI, Unified Extensible Firmware Interface, or BIOS, Basic Input Output System). As the operation of the one or more hardware address determination circuitries/means 12, 13 may be controlled by the microcontroller 14, the operation of the one or more hardware address determination circuitries/means 12, 13 may also be defined by software being executed by the microcontroller 14.

In the proposed concept, the one or more hardware address determination circuitries 12, 13 or one or more hardware address determination means 12, 13 are configured to determine a mapping between a physical memory address (i.e., memory address in physical address space, as used by software running on the computer system 100) and a hardware location address (e.g., row, column) of corresponding memory 101, 102 of the computer system 100 (e.g., local DRAM or memory attached via a peripheral bus, such as Peripheral Component Interconnect Express, PCIe). In particular, the one or more hardware address determination circuitries 12, 13 or one or more hardware address determination means 12, 13 are configured to adapt the mapping at run-time, upon obtaining updated information identifying at least one defective memory hardware location.

FIG. 1b shows a flowchart of a corresponding method for handling defective memory hardware locations. The method comprises storing 110, information identifying at least one defective memory hardware location. The method comprises determining 130, by the one or more hardware address determination circuitries 12, 13, a mapping between a physical memory address and a hardware location address of corresponding memory 101, 102. The method comprises obtaining 140, the updated information identifying at least one defective memory hardware location. The method comprises adapting 160, by the one or more hardware address determination circuitries 12, 13, the mapping at run-time upon obtaining the updated information identifying at least one defective memory hardware location. For example, the method may be performed by the computer system 100, e.g., by the apparatus 10 or device 10 of the computer system 100.

In the following, the features of the apparatus 10, device 10, computer system 100, and of the method of FIG. 1b will be introduced in more detail with reference to the apparatus 10 (and, in parts, the method of FIG. 1b). Features discussed in connection with the apparatus 10 may likewise be included in the corresponding device 10, method, and computer system 100.

Various examples of the present disclosure are based on the finding that dynamically adapting memory mappings in a computer system with hardware support can improve performance in the presence of defective memory hardware without requiring complex operating system-based offlining features, which may take offline more memory locations than are actually affected by the hardware defect. The proposed concept allows the system to continue operating despite memory failures, thereby reducing downtime and data loss.

The proposed concept is based on employing the hardware address determination circuitries 12, 13, which are, in other memory systems, used for striping memory accesses across multiple channels of memory, for the purpose of dealing with defective memory. For this purpose, the hardware address determination circuitries 12, 13 have access to information identifying at least one defective memory hardware location. For example, the hardware address determination circuitries 12, 13 may read out the information identifying at least one defective memory hardware location from the (non-volatile) memory circuitry 11, or the microcontroller 14 may use the stored information identifying at least one defective memory hardware location to control/program the hardware address determination circuitries 12, 13. The hardware address determination circuitries 12, 13 use this information to determine a mapping between the addresses in physical address space (as used by software, such as the operating system of the computer system 100), to hardware addresses (e.g., channel, row, column) of the corresponding memory 100.

In the ideal case, the memory 101 of the computer system 100 starts out without any defective memory hardware locations. Over time, the memory 101 may accumulate defective memory hardware locations, e.g., rows or columns that cannot be reliably read or written. For example, the memory controller of the computer system 100 may alert the microcontroller 14 of such memory hardware locations (i.e., the microcontroller 14 may obtain updated information identifying at least one defective memory hardware location), and the microcontroller 14 may update the stored information identifying at least one defective memory hardware location stored in the memory circuitry 11. In other words, the microcontroller circuitry 14 may manage (update, e.g., in response to newly identified defective memory hardware locations) the information identifying at least one defective memory hardware location stored in the memory circuitry. As a result, the microcontroller circuitry 14 also knows how much memory (i.e., how many rows, columns, channels of memory) is/are actually available for use by the memory system. This information may be reported to the operating system. In other words, the microcontroller circuitry 14 may be configured to report an amount of available memory based on the information identifying the at least one defective memory hardware location. Accordingly, the method may comprise reporting 120 the amount of available memory based on the information identifying the at least one defective memory hardware location.

Depending on implementation, the hardware address determination circuitries 12, 13 may automatically adapt their mapping based on the updated information identifying at least one defective memory hardware location stored in the memory circuitry 11, or the microcontroller 14 may trigger the hardware address determination circuitries 12, 13 to read the updated information identifying at least one defective memory hardware location from the memory circuitry 11, or the microcontroller 14 may actively instruct the individual hardware address determination circuitries 12, 13 to adapt the mapping. In other words, in the latter two cases, in some examples, the microcontroller circuitry 14 may be configured to instruct the one or more hardware address determination circuitries to adapt the mapping. Accordingly, the method of FIG. 1b may comprise instructing 145, by the microcontroller 140, the one or more hardware address determination circuitries to adapt the mapping.

While there are various ways of adapting the mapping, the goal in both cases is to increase or maximize the amount of available memory. In other words, adapting the mapping may be performed with the goal of increasing or maximizing the amount of memory available to the operating system. To illustrate this approach, an example is given—in traditional software-based remapping, a memory region of 4 K memory being defective may lead to substantially more memory being unavailable, in particular when the physical memory addresses are mapped to the hardware in a striped manner. For example, if four memory channels are used, scenarios may arise in which four different 4 K pages of memory all use 4 K of memory from the defective memory region, leading to 16 K of memory being offlined. In the proposed concept, this can be avoided, as only the defective memory region can be masked. This can be done by performing the remapping in a manner that only a reduced or minimal set of physical hardware addresses is affected by the remapping, i.e., one 4 K page in case of a 4 K memory region being defective. In other words, the one or more hardware address determination circuitries 12, 13 may be configured to determine a reduced or minimal set of physical hardware addresses affected by the at least one defective memory hardware location, and to adapt the mapping based on the reduced or minimal set of physical hardware addresses. Accordingly, the method may comprise determining 150 a reduced or minimal set of physical hardware addresses affected by the at least one defective memory hardware location, and adapting the mapping based on the reduced or minimal set of physical hardware addresses. For example, the reduced or minimal set of physical hardware addresses affected by the at least one defective memory hardware location may represent an amount of memory corresponding to the amount of memory being unavailable due to being defective.

In general, two different mechanisms may be used to adapt the mapping. In a first, straightforward implementation, the one or more hardware address determination circuitries 12, 13 may use a look-up table to identify addresses (in physical address space) that would map to defective hardware addresses, and to use an alternate address stored in the look-up table to determine the mapping of these addresses. In other words, the one or more hardware address determination circuitries 12, 13 may be configured to adapt the mapping based on a data structure (i.e., the look-up table) of one or more mappings between a physical memory address affected by at least one defective memory hardware location and a corresponding replacement hardware location address. This approach is limited by the maximal number of entries in the data structure, and may result in delays if the look-up takes too long. Moreover, it may have to be performed by the most upper-level hardware address determination circuitry to enable reallocation across memory channels. In other words, if the apparatus 10 comprises a plurality of hardware address determination circuitries associated with two or more hierarchy levels (e.g., higher-level hardware address determination circuitry 12 being used across memory channels, and lower-level hardware address determination circuitries 13 associated with a specific memory channel), a hardware address determination circuitry at the top hierarchy level may be configured to adapt the mapping based on the data structure of mappings.

To address the limitations of the replacement address-based approach, another approach based on shifting may be used. For example, the one or more hardware address determination circuitries 12, 13 may adapt the mapping by shifting the mapping for every defective location (affecting this hardware address determination circuitry). This means that, once the “conventional mapping” between a physical memory address used by the software reaches a hardware address that is defective, the mapping is shifted to an (e.g., the next higher) address unaffected by the defect. To give a simplified example—instead of mapping physical memory addresses a, b, c, d, e, f, g to hardware addresses 1, 2, 3, 4, 5, 6, 7, if hardware address 4 is defective, the physical memory addresses may be mapped to 1, 2, 3, 5, 6, 7, 8 (leaving a gap at 4). Accordingly, the one or more hardware address determination circuitries may be configured to adapt the mapping by shifting the mapping between a physical memory address and a hardware location address based on a hardware location and number of a set of physical hardware addresses affected by the at least one defective memory hardware location. The hardware location of the hardware addresses affected by the at least one defective memory hardware location affect “where” the shift is made (i.e., the position of the shift), while the number of the hardware addresses affected by the at least one defective memory hardware location affect “how big” the shift is (i.e., the size/distance of the shift).

This principle can also be used independently by the hardware address determination circuitries 12, 13, when memory striping is used. Memory striping is the interleaving of physical memory addresses across two or more memory channels so that successive blocks (often at cache-line granularity) are placed on different DIMMs (Dual In-line Memory Module)/channels. In many cases, this may be done using a hashing function, e.g., a hashing function based on the modulo operator. For example, the one or more hardware address determination circuitries may be configured to determine a mapping between a physical memory address and a hardware location address of corresponding memory using a hashing function, thereby performing memory striping across a plurality of memory circuitries 101. Regarding address shifting, if the hardware location addresses are striped across a plurality of memory circuitries (e.g., a plurality of memory channels), shifting may be performed for a memory circuitry based on a hardware location and the number of a set of physical hardware addresses affected by the at least one defective memory hardware location of that memory circuitry. In other words, shifting might only be used if the memory circuitry associated with that specific hardware address determination circuitry 12, 13 includes the defective memory hardware locations.

The initial overhead of using shifting instead of straight-forward address replacement may be considerable, as simply activating the shift as soon as the defective memory is detected would mean the data retrieved from the memory is “off” by the amount of the shift (e.g., in one of the channels). To ensure data integrity, as part of enabling the shifting process, the data stored in the memory may be copied/moved to the new “correct” location. In other words, the one or more hardware address determination circuitries (or a component of a memory controller of the computer system) may be configured to copy the content of memory from a hardware location address associated with a physical memory address prior to shifting the mapping to a hardware location address associated with the physical memory address after shifting the mapping.

In general, both methods of adapting the mapping have advantages and disadvantages. For example, the use of replacement hardware addresses is primarily applicable to address a small number of defective hardware addresses, while the shifting-based mechanism has an increased effort to ensure that the shifting does not affect the data currently stored in the memory. Therefore, a hybrid approach may be used, where initially the replacement address-based approach is used, with a switch to the shifting-based approach being performed when a criterion is met (e.g., load of the computer system, number of replacement addresses used, time schedule). For example, the one or more hardware address determination circuitries 12, 13 may be configured to initially adapt the mapping based on a data structure of one or more mappings between a physical memory address affected by the at least one defective memory hardware location and a corresponding replacement hardware location address, and to switch to adapting the mapping by shifting the mapping when the condition is met. Accordingly, the method of FIG. 1b may comprise initially adapting 160 by the one or more hardware address determination circuitries, the mapping based on a data structure of one or more mappings between a physical memory address affected by the at least one defective memory hardware location and a corresponding replacement hardware location address, and switching 170 by the one or more hardware address determination circuitries to adapting the mapping by shifting the mapping when the condition is met. For example, the condition may be based on an availability of replacement hardware location addresses (i.e., the switch may be performed when the number of available replacement hardware location addresses reaches a threshold), based on a time schedule (e.g., each day at 2 am) and/or based on a load of the computer system (e.g., when the load has been low (e.g., below 0.1) for at least 5 minutes). The latter is particularly important in case the content of memory has to be copied, i.e., if the one or more hardware address determination circuitries (or the memory controller) have to copy the content of memory from a hardware location address associated with a physical memory address prior to shifting the mapping to a hardware location address associated with the physical memory address after shifting the mapping. Accordingly, the method of FIG. 1b may comprise copying 175 the content of memory from a hardware location address associated with a physical memory address prior to shifting the mapping to a hardware location address associated with the physical memory address after shifting the mapping.

The proposed concept is not limited to memory connected to a central processing unit (CPU) of the computer system via a dedicated memory bus/dedicated memory channels, but also memory that is connected via an interconnect bus, such as PCIe. In other words, the one or more hardware address determination circuitries may be configured to determine a mapping between a physical memory address and a hardware location address of corresponding memory 102, connected to the computer system via a bus for attaching peripheral devices to the computer system, such as the peripheral component interconnect express (PCIe) bus.

For example, the non-volatile memory circuitry 11 may correspond to one or more memory components designed to store and/or retain information without requiring a continuous power supply. This information can be in digital (bit) values according to a specified code, whether stored temporarily or permanently within a module. For example, the non-volatile memory circuitry 11 may include flash memory, EEPROM, or other non-volatile storage elements configured to preserve data even when power is removed.

For example, the one or more one or more hardware address determination circuitries 12, 13 may be circuitries designed and configured to derive a hardware address of a memory based on an address of a physical address space (physical hardware address). For example, the one or more hardware address determination circuitries 12, 13 may be implemented as separate hardware circuitries or be implemented on a shared integrated circuit. For example, the one or more hardware address determination circuitries 12, 13 may be part of a memory controller of the computer system 100.

The microcontroller circuitry 14 may correspond to one or more processing components designed to execute instructions and/or control operations. These operations can involve processing digital (bit) values according to specified programs, which may be executed within a single module, coordinated between different modules, or synchronized with modules of distinct entities. For example, the microcontroller circuitry 14 may include a processor, control logic, and associated circuitry configured to perform computational and control functions.

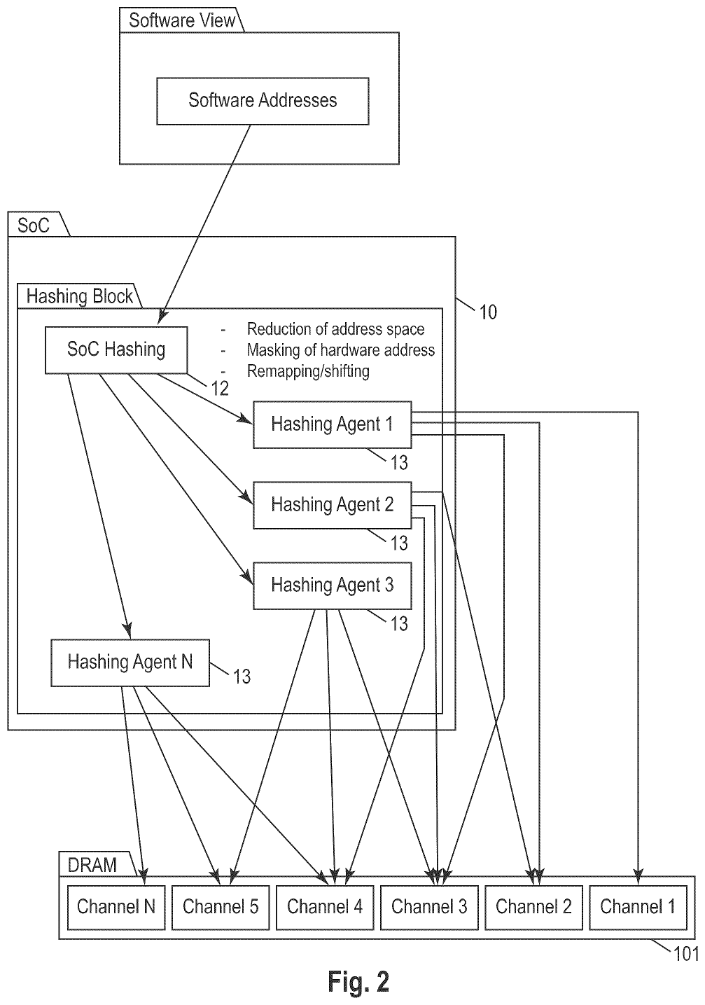

More details and aspects of the apparatus 10, device 10, computer system 100, and the method of FIG. 1b are mentioned in connection with the proposed concept or one or more examples described above or below (e.g. FIG. 2 to 4). The apparatus 10, device 10, computer system 100, and the method of FIG. 1b may comprise one or more additional optional features corresponding to one or more aspects of the proposed concept or one or more examples described above or below.

The proposed concept addresses the challenge of handling memory errors in systems with multiple memory (e.g., Dynamic Random Access Memory, DRAM) devices and many channels that have limited or no hardware repair mechanism. By leveraging hardware-assisted memory page offline mechanisms, it reduces or minimizes the impact of bad hardware locations by masking and remapping affected memory addresses. This approach ensures system stability and performance by reducing the amount of memory that needs to be offlined, while maintaining operational continuity without requiring software intervention and tracking like previous software page-offline solutions. It provides a scalable and efficient way to manage memory errors in multi-channel memory systems.

The hardware-assisted memory page offline mechanism leverages one or more hashing engines 12, 13 (see FIGS. 1a, 2, 3) that map software addresses (system physical addresses) to hardware locations in memory (DRAM) devices 101. The hardware-assisted memory page offline feature may use the hashing engine to mask bad hardware addresses and shift software addresses to alternative physical locations. This eliminates the need to offline more memory regions than the amount of hardware addresses determined to be avoided, limiting the impact to only the bad memory. By leveraging this shift in the hardware, software only needs to reduce the total size of memory that is usable in the device, and no longer needs to track all individual offlined pages.

The proposed design reduces or minimizes memory loss by limiting the deallocation to only the bad hardware memory, rather than mapping larger software address spaces into the bad hardware memory addresses, ensuring efficient use of available memory. It leverages hardware-assisted hashing engines to dynamically mask and remap bad memory locations, reducing the need for software intervention. By maintaining operational continuity and enabling runtime adjustments, the design ensures system stability and performance without requiring a full reboot.

When using the proposed concept, memory failures may lead to a reduction of software-visible memory due to the row or column-level impact of the DRAM. This reduction in memory may arise at the top of memory and be observable as a lower usable size. The computer system may dynamically adjust memory capacity from the top of memory at runtime, with bad memory regions being effectively masked. The hashing agents may be programmed via the BIOS (Basic Input/Output System) or other firmware, with capabilities to mask and shift incoming addresses mapped to hardware addresses.

The proposed design leverages a hardware-assisted memory page offline mechanism to address the challenges posed by bad memory locations in DRAM devices. At the core of the proposed concept are the hashing agent(s) (i.e., the hardware address determination circuitries 12, 13), which map software addresses (system physical addresses) to hardware locations in DRAM. This may be a single agent or may be multiple agents. This mapping ensures that memory is striped across multiple DRAM devices, improving performance and enabling efficient memory utilization.

FIG. 2 shows a schematic diagram of an address path to hardware. It shows the following components: The hashing agents 12, 13 act as an intermediary between the software view of memory and the physical DRAM devices 101. They may ensure that memory addresses are distributed across multiple channels, reducing the likelihood of bottlenecks and improving overall system performance. The hashing agents may be enhanced as part of the hardware-assisted page offline feature to allow masking and shifting of addresses to avoid bad DRAM locations. Dynamic address masking may be used, so when a bad memory location is detected, the hashing engine may mask the affected address. This prevents software from accessing the bad memory region, ensuring system stability. Address remapping may be used, so the hashing engine remaps/shifts the incoming addresses to an alternative physical location, avoiding the masked hardware address. This allows the system to continue operating without requiring a full reboot or extensive software intervention. This works by reducing the total available memory by the same amount as “bad in dram”, which allows the system to skip the bad memory location while still accessing a continuous address space from software view.

In the following, a system with multiple DRAM channels, managed by a hashing agent or agent(s) 12, 13 is considered. If a bad memory location is detected in one of the DRAM devices 101, the following operations occur. (1) Detection: The system identifies the bad memory location, such as a 4 KB row in a DRAM device. (2) Masking: The hashing engine masks the bad address, preventing software from accessing it. (3) Remapping (i.e., adapting the mapping): The hashing engine remaps the incoming addresses from software to an alternative location, ensuring that software can continue to access a contiguous memory space. (4) Capacity Adjustment: The system reduces the total reported memory capacity by the size of the bad memory region (e.g., 4 KB). This adjustment is transparent to the software, which sees a unified memory space. The hashing agent(s) must ensure that the reduction in total capacity is applied to the hashing agent(s) with fewer hardware addresses available.

The proposed concept enables a reduced or minimized memory loss: By limiting the deallocation to the size of the bad hardware memory, the design ensures efficient use of available memory. For example, instead of offlining 16 KB of memory due to a bad 4 KB row (1K hashing, 4K row, 8 SW pages), only the affected 4 KB may be masked and remapped. If lower granularity hashing is used, the impacted memory of traditional software page-offline is more (e.g., 32 KB for 512 B hashing). The proposed concept further enables software transparency: The offline process is hidden from software, which sees a reduced memory capacity without needing to manage deallocation explicitly. This simplifies software design and reduces the risk of errors.

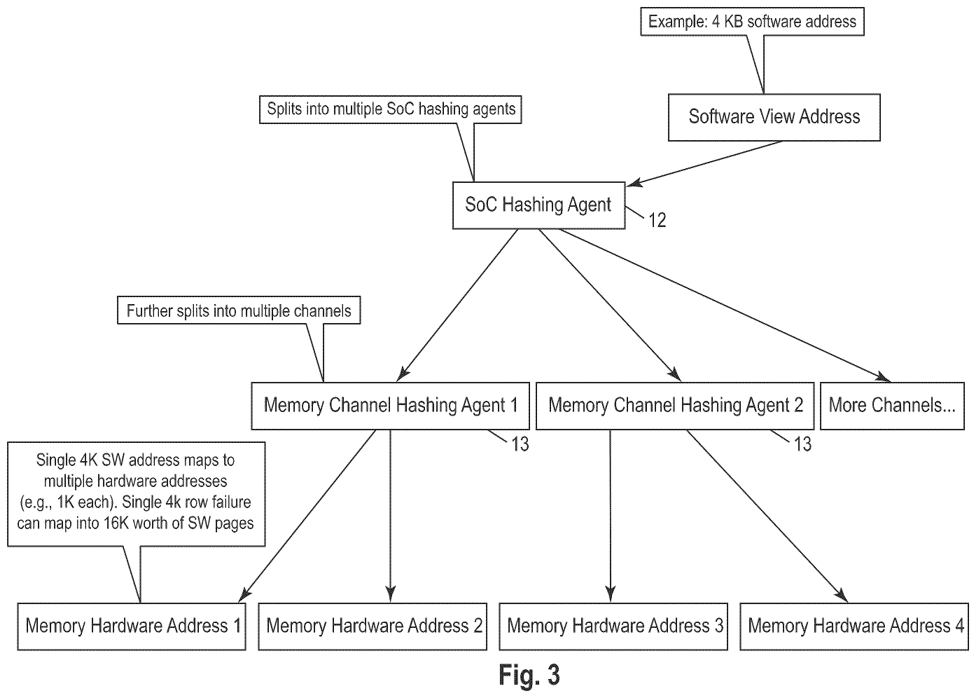

FIG. 3 shows a schematic diagram of a split hashing view. In FIG. 3, it is shown how a single software page maps to many memory hardware addresses. Masking any bad hardware address at the lower order hashing Agent and remapping/shifting the incoming SW addresses around it, while only lowering the total memory capacity, limits the memory capacity impact.

In a multi-channel DRAM system, a bad memory location is detected in one channel. The hashing engine identifies the affected address range and masks it. Any prior errors (bad data) from the bad address may be handled by existing error-handling flows. Once the hardware-assisted page-offline feature has masked the bad address and reduced the usable memory size, the software can continue operating normally, accessing memory through the hashing engine. The total memory capacity is reduced by the size of the bad memory region being avoided. The remapping/shifting in the hashing agent(s) allows the SW page that was previously hashing into the bad memory to now access a good hardware memory address.

The total addressable size of any specific hashing agent impact may be represented as being reduced by any higher order hashing agent. The sum of all reductions may be represented as the reduced capacity to the host. Each level of hashing agent may remap/shift the incoming addresses to avoid the masked address. This expanded design ensures that memory errors may be handled gracefully, maintaining system stability and performance while minimizing the impact on software and overall memory capacity.

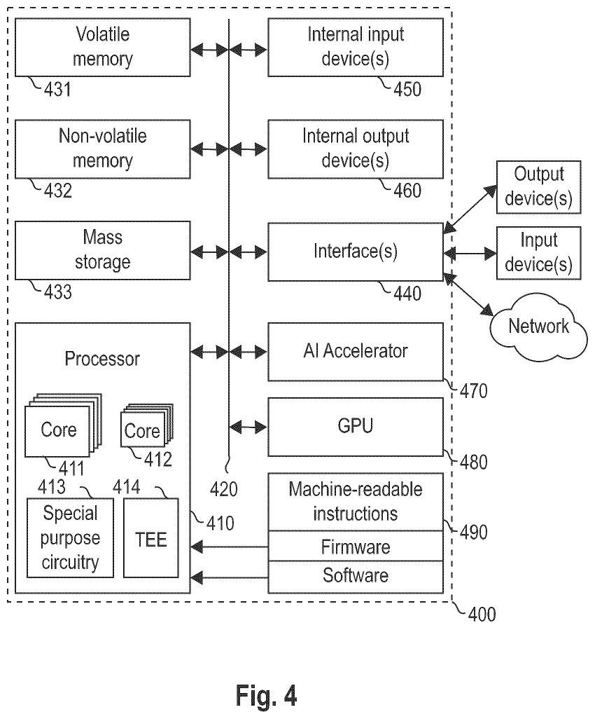

More details and aspects of the hardware-assisted page offline feature are mentioned in connection with the proposed concept, or one or more examples described above or below (e.g., FIG. 1a to 1b, FIG. 4). The hardware-assisted page offline feature may comprise one or more additional optional features corresponding to one or more aspects of the proposed concept, or one or more examples described above or below.

FIG. 4 shows a block diagram of an example computer system 400 or computing device 400 structured to execute and/or instantiate the machine-readable instructions and/or operations of FIGS. 1a to 3 in order to implement the apparatus, device, or method for handling defective memory hardware locations. The computer system 400 or computing device 400 may be, for example, a server, a personal computer, a workstation, a self-learning machine (e.g., a neural network), a mobile device (e.g., a cell phone, a smartphone, a tablet such as an iPad™), a personal digital assistant (PDA), an Internet appliance, a DVD player, a CD player, a digital video recorder, a Blu-ray player, a gaming console, a personal video recorder, a set-top box, a headset (e.g., an augmented reality (AR) headset, a virtual reality (VR) headset, etc.) or other wearable device, or any other type of computing device.

The computer system 400 or computing device 400 of the illustrated example includes processor circuitry 410. The processor circuitry 410 of the illustrated example is hardware. For example, the processor circuitry 410 can be implemented by one or more integrated circuits, logic circuits, FPGAs (Field-Programmable Gate Array), microprocessors, CPUs (Central Processing Units), GPUs (Graphics Processing Units), DSPs (Digital Signal Processors), and/or microcontrollers from any desired family or manufacturer. The processor circuitry 410 may be implemented by one or more semiconductor-based (e.g., silicon-based) devices. For example, the processor circuitry 410 may provide the functionality of the computer system 400 or computing device 400. Accordingly, the computing system being used to implement the proposed concept may be a CPU-based computing system, a GPU based computing system, an AI Accelerator computing system, or any other computing system that uses volatile memory. The computing system that implements this solution may be a sub-part of a larger computing system. For example, the computer system 100 of FIG. 1a may be one of a CPU-based computing system, a GPU based computing system, an AI Accelerator computing system, or any other computing system that uses volatile memory.

The processor circuitry 410 comprises one or more processor cores 411, 412. For example, the processor circuitry 410 may have heterogeneous cores. Heterogeneous cores in CPUs refer to the use of different types of cores within a single processor, typically combining high-performance (BIG) cores with power-efficient (LITTLE) cores. Thus, the processor circuitry 410 may comprise one or more BIG cores 411 and one or more LITTLE cores 412. BIG cores are designed for performance-intensive tasks and provide higher processing power, but they consume more energy. LITTLE cores, on the other hand, are optimized for energy efficiency and handle less demanding tasks to prolong battery life and reduce power consumption.

The processor circuitry 410 of the illustrated example is in communication with, e.g., via one or more bus interfaces 420, the main memory including a volatile memory 431 and a non-volatile memory 432. The volatile memory 431 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 432 may be implemented by flash memory and/or any other desired type of memory device. Access to the main memory 431, 432 of the illustrated example is controlled by a memory controller, which may be implemented by special-purpose circuitry 413 of the processor circuitry 410.

The computer system 400 or computing device 400 of the illustrated example also includes one or more mass storage devices 433 to store software and/or data. Examples of such mass storage devices 433 include magnetic storage devices, optical storage devices, floppy disk drives, HDDs, CDs, Blu-ray disk drives, redundant array of independent disks (RAID) systems, solid state storage devices such as flash memory devices, and DVD drives.

The computer system 400 or computing device 400 of the illustrated example also includes interface circuitry 440. The interface circuitry 440 may be implemented by hardware in accordance with any type of interface standard, such as an Ethernet interface, a WiFi interface, a cellular modem, a universal serial bus (USB) interface, a Bluetooth® interface, a near field communication (NFC) interface, a PCI (Peripheral Component Interconnect) interface, and/or a PCIe (Peripheral Component Interconnect Express) interface. For example, the interface circuitry 440 of the illustrated example may include a communication device such as a transmitter, a receiver, a transceiver, a modem, a residential gateway, a wireless access point, and/or a network interface to facilitate exchange of data with external machines (e.g., computing devices of any kind) by a network. The communication can be by, for example, an Ethernet connection, a digital subscriber line (DSL) connection, a telephone line connection, a coaxial cable system, a satellite system, a line-of-sight wireless system, a cellular telephone system, an optical connection, etc.

In the illustrated example, one or more internal input devices 450 and/or one or more external input devices are connected to the interface circuitry 440 or the bus 420. The input device(s) permit a user to enter data and/or commands into the processor circuitry 410. The input device(s) can be implemented by, for example, an audio sensor, a microphone, a camera (still or video), a keyboard, a button, a mouse, a touchscreen, a trackpad, a trackball, an isopoint device, and/or a voice recognition system.

One or more internal output devices 460 and/or one or more external output devices are also connected to the interface circuitry 440 of the illustrated example. The output devices 460 can be implemented, for example, by display devices (e.g., a light emitting diode (LED), an organic light emitting diode (OLED), a liquid crystal display (LCD), a cathode ray tube (CRT) display, an in-plane switching (IPS) display, a touchscreen, etc.), a tactile output device, a printer, and/or speaker. The computer system 400 or computing device 400 of the illustrated example, thus, typically includes a graphics driver card, a graphics driver chip, and/or graphics processor circuitry such as a GPU 413, 480, which may correspond to or be part of the processor circuitry 410, for example as special purpose circuitry 413, or as cores 411, 412, or separate from the processor 410, for example as a separate GPU 480.

The computer system 400 or computing device 400 of the illustrated example may include an AI Accelerator 470. For example, the AI Accelerator 470 may be configured to improve the computational speed and efficiency of machine learning tasks by executing parallel processing operations tailored for neural network models. The AI Accelerator 470 may include hardware such as Graphics Processing Units (GPUs), Tensor Processing Units (TPUs), or other specialized processors designed to handle large volumes of data with low latency. For example, the Processor 410, the AI Accelerator 470, the integrated GPU 413, and/or the dedicated GPU 480 may be considered xPUs (x Processing Units, where x is a placeholder) of the computer system 700 or computing device 700.

The computer system 400 or computing device 400 of the illustrated example includes machine-readable instructions 490. For example, the machine-readable instructions may be part of firmware or software of the computer system 400 or computing device 400. The machine-readable instructions 490 may be stored in the mass storage device 433, in the volatile memory 431, in the non-volatile memory 432, and/or on a removable non-transitory computer-readable storage medium such as a CD or DVD.

In the following, some examples of the proposed concept are presented:

An example (e.g., example 1) relates to an apparatus (10) for a computer system (100), comprising memory circuitry (11) for storing information identifying at least one defective memory hardware location, and one or more hardware address determination circuitries (12, 13) configured to determine a mapping between a physical memory address and a hardware location address of corresponding memory (101, 102), wherein the one or more hardware address determination circuitries are configured to adapt the mapping at run-time upon obtaining updated information identifying at least one defective memory hardware location.

Another example (e.g., example 2) relates to a previous example (e.g., example 1) or to any other example, further comprising that the apparatus comprises circuitry (14) configured to report an amount of available memory based on the information identifying the at least one defective memory hardware location.

Another example (e.g., example 3) relates to a previous example (e.g., one of the examples 1 or 2) or to any other example, further comprising that the one or more hardware address determination circuitries are configured to determine a reduced or minimal set of physical hardware addresses affected by the at least one defective memory hardware location, and to adapt the mapping based on the reduced or minimal set of physical hardware addresses.

Another example (e.g., example 4) relates to a previous example (e.g., one of the examples 1 to 3) or to any other example, further comprising that the one or more hardware address determination circuitries are configured to determine a mapping between a physical memory address and a hardware location address of corresponding memory using a hashing function, thereby performing memory striping across a plurality of memory circuitries (101).

Another example (e.g., example 5) relates to a previous example (e.g., one of the examples 1 to 4) or to any other example, further comprising that the one or more hardware address determination circuitries are configured to adapt the mapping by shifting the mapping between a physical memory address and a hardware location address based on a hardware location and number of a set of physical hardware addresses affected by the at least one defective memory hardware location.

Another example (e.g., example 6) relates to a previous example (e.g., example 5) or to any other example, further comprising that if the hardware location addresses are striped across a plurality of memory circuitries, shifting is performed for a memory circuitry based on a hardware location and number of a set of physical hardware addresses affected by the at least one defective memory hardware location of that memory circuitry.

Another example (e.g., example 7) relates to a previous example (e.g., one of the examples 5 or 6) or to any other example, further comprising that the one or more hardware address determination circuitries are configured to initially adapt the mapping based on a data structure of one or more mappings between a physical memory address affected by the at least one defective memory hardware location and a corresponding replacement hardware location address, and to switch to adapting the mapping by shifting the mapping when a condition is met.

Another example (e.g., example 8) relates to a previous example (e.g., example 7) or to any other example, further comprising that the condition is based on an availability of replacement hardware location addresses.

Another example (e.g., example 9) relates to a previous example (e.g., one of the examples 7 or 8) or to any other example, further comprising that the condition is based on a time schedule.

Another example (e.g., example 10) relates to a previous example (e.g., one of the examples 7 to 9) or to any other example, further comprising that the condition is based on a load of the computer system.

Another example (e.g., example 11) relates to a previous example (e.g., one of the examples 5 to 10) or to any other example, further comprising that the one or more hardware address determination circuitries are configured to copy a content of memory from a hardware location address associated with a physical memory address prior to shifting the mapping to a hardware location address associated with the physical memory address after shifting the mapping.

Another example (e.g., example 12) relates to a previous example (e.g., one of the examples 1 to 11) or to any other example, further comprising that the one or more hardware address determination circuitries are configured to adapt the mapping based on a data structure of one or more mappings between a physical memory address affected by the at least one defective memory hardware location and a corresponding replacement hardware location address.

Another example (e.g., example 13) relates to a previous example (e.g., example 12) or to any other example, further comprising that the apparatus comprises a plurality of hardware address determination circuitries associated with two or more hierarchy levels, wherein a hardware address determination circuitry at a top hierarchy level is configured to adapt the mapping based on the data structure of mappings.

Another example (e.g., example 14) relates to a previous example (e.g., one of the examples 1 to 13) or to any other example, further comprising that the one or more hardware address determination circuitries are configured to determine a mapping between a physical memory address and a hardware location address of corresponding memory (102) connected to the computer system via a bus for attaching peripheral devices to the computer system.

Another example (e.g., example 15) relates to a previous example (e.g., example 14) or to any other example, further comprising that the bus is a peripheral component interconnect express bus.

Another example (e.g., example 16) relates to a previous example (e.g., one of the examples 1 to 15) or to any other example, further comprising that the apparatus comprises microcontroller circuitry (14) configured to manage the information identifying at least one defective memory hardware location stored in the memory circuitry.

Another example (e.g., example 17) relates to a previous example (e.g., example 16) or to any other example, further comprising that the microcontroller circuitry (14) is configured to instruct the one or more hardware address determination circuitries to adapt the mapping.

Another example (e.g., example 18) relates to a previous example (e.g., one of the examples 1 to 17) or to any other example, further comprising that the information identifying at least one defective memory hardware location is stored in non-volatile memory circuitry (12).

Another example (e.g., example 19) relates to a computer system (100) comprising the apparatus (10) according to one of the examples 1 to 18.

Another example (e.g., example 20) relates to a previous example (e.g., example 19) or to any other example, further comprising that the computer system further comprises the memory (101, 102).

An example (e.g., example 21) relates to a device (10) for a computer system (100), comprising means (11) for storing information identifying at least one defective memory hardware location, and one or more hardware address determination means (12, 13) configured to determine a mapping between a physical memory address and a hardware location address of corresponding memory (101, 102), wherein the one or more hardware address determination means are configured to adapt the mapping at run-time upon obtaining updated information identifying at least one defective memory hardware location.

Another example (e.g., example 22) relates to a previous example (e.g., example 21) or to any other example, further comprising that the device comprises means (14) configured to report an amount of available memory based on the information identifying the at least one defective memory hardware location.

Another example (e.g., example 23) relates to a previous example (e.g., one of the examples 21 or 22) or to any other example, further comprising that the one or more hardware address determination means are configured to determine a reduced or minimal set of physical hardware addresses affected by the at least one defective memory hardware location, and to adapt the mapping based on the reduced or minimal set of physical hardware addresses.

Another example (e.g., example 24) relates to a previous example (e.g., one of the examples 21 to 23) or to any other example, further comprising that the one or more hardware address determination means are configured to determine a mapping between a physical memory address and a hardware location address of corresponding memory using a hashing function, thereby performing memory striping across a plurality of memory circuitries (101).

Another example (e.g., example 25) relates to a previous example (e.g., one of the examples 21 to 24) or to any other example, further comprising that the one or more hardware address determination means are configured to adapt the mapping by shifting the mapping between a physical memory address and a hardware location address based on a hardware location and number of a set of physical hardware addresses affected by the at least one defective memory hardware location.

Another example (e.g., example 26) relates to a previous example (e.g., example 25) or to any other example, further comprising that if the hardware location addresses are striped across a plurality of memory circuitries, shifting is performed for a memory circuitry based on a hardware location and number of a set of physical hardware addresses affected by the at least one defective memory hardware location of that memory circuitry.

Another example (e.g., example 27) relates to a previous example (e.g., one of the examples 25 or 26) or to any other example, further comprising that the one or more hardware address determination means are configured to initially adapt the mapping based on a data structure of one or more mappings between a physical memory address affected by the at least one defective memory hardware location and a corresponding replacement hardware location address, and to switch to adapting the mapping by shifting the mapping when a condition is met.

Another example (e.g., example 28) relates to a previous example (e.g., example 27) or to any other example, further comprising that the condition is based on an availability of replacement hardware location addresses.

Another example (e.g., example 29) relates to a previous example (e.g., one of the examples 27 or 28) or to any other example, further comprising that the condition is based on a time schedule.

Another example (e.g., example 30) relates to a previous example (e.g., one of the examples 27 to 29) or to any other example, further comprising that the condition is based on a load of the computer system.

Another example (e.g., example 31) relates to a previous example (e.g., one of the examples 25 to 30) or to any other example, further comprising that the one or more hardware address determination means are configured to copy a content of memory from a hardware location address associated with a physical memory address prior to shifting the mapping to a hardware location address associated with the physical memory address after shifting the mapping.

Another example (e.g., example 32) relates to a previous example (e.g., one of the examples 21 to 31) or to any other example, further comprising that the one or more hardware address determination means are configured to adapt the mapping based on a data structure of one or more mappings between a physical memory address affected by the at least one defective memory hardware location and a corresponding replacement hardware location address.

Another example (e.g., example 33) relates to a previous example (e.g., example 32) or to any other example, further comprising that the device comprises a plurality of hardware address determination means associated with two or more hierarchy levels, wherein a hardware address determination means at a top hierarchy level is configured to adapt the mapping based on the data structure of mappings.

Another example (e.g., example 34) relates to a previous example (e.g., one of the examples 21 to 33) or to any other example, further comprising that the one or more hardware address determination means are configured to determine a mapping between a physical memory address and a hardware location address of corresponding memory (102) connected to the computer system via a bus for attaching peripheral devices to the computer system.

Another example (e.g., example 35) relates to a previous example (e.g., example 34) or to any other example, further comprising that the bus is a peripheral component interconnect express bus.

Another example (e.g., example 36) relates to a previous example (e.g., one of the examples 21 to 35) or to any other example, further comprising that the device comprises a microcontroller (14) configured to manage the information identifying at least one defective memory hardware location stored in the memory circuitry.

Another example (e.g., example 37) relates to a previous example (e.g., example 36) or to any other example, further comprising that the microcontroller (14) is configured to instruct the one or more hardware address determination means to adapt the mapping.

Another example (e.g., example 38) relates to a previous example (e.g., one of the examples 21 to 37) or to any other example, further comprising that the information identifying at least one defective memory hardware location is stored in non-volatile memory (12).

Another example (e.g., example 39) relates to a computer system (100) comprising the device (10) according to one of the examples 21 to 38.

Another example (e.g., example 40) relates to a previous example (e.g., example 39) or to any other example, further comprising that the computer system further comprises the memory (101, 102).

An example (e.g., example 41) relates to a method (10) for a computer system (100), comprising storing (110) information identifying at least one defective memory hardware location, and determining (130), by one or more hardware address determination circuitries (12, 13), a mapping between a physical memory address and a hardware location address of corresponding memory (101, 102), adapting (160), by the one or more hardware address determination circuitries, the mapping at run-time upon obtaining (140) updated information identifying at least one defective memory hardware location.

Another example (e.g., example 42) relates to a previous example (e.g., example 41) or to any other example, further comprising that the method comprises reporting (120) an amount of available memory based on the information identifying the at least one defective memory hardware location.

Another example (e.g., example 43) relates to a previous example (e.g., one of the examples 41 or 42) or to any other example, further comprising that the method comprises determining (150) a reduced or minimal set of physical hardware addresses affected by the at least one defective memory hardware location, and adapting the mapping based on the reduced or minimal set of physical hardware addresses.

Another example (e.g., example 44) relates to a previous example (e.g., one of the examples 41 to 43) or to any other example, further comprising that the method comprises determining (130), by the one or more hardware address determination circuitries, a mapping between a physical memory address and a hardware location address of corresponding memory using a hashing function, thereby performing memory striping across a plurality of memory circuitries (101).

Another example (e.g., example 45) relates to a previous example (e.g., one of the examples 41 to 44) or to any other example, further comprising that the method comprises adapting (160), by the one or more hardware address determination circuitries, the mapping by shifting the mapping between a physical memory address and a hardware location address based on a hardware location and number of a set of physical hardware addresses affected by the at least one defective memory hardware location.

Another example (e.g., example 46) relates to a previous example (e.g., example 45) or to any other example, further comprising that if the hardware location addresses are striped across a plurality of memory circuitries, shifting is performed for a memory circuitry based on a hardware location and number of a set of physical hardware addresses affected by the at least one defective memory hardware location of that memory circuitry.

Another example (e.g., example 47) relates to a previous example (e.g., one of the examples 45 or 46) or to any other example, further comprising that the method comprises initially adapting (160), by the one or more hardware address determination circuitries, the mapping based on a data structure of one or more mappings between a physical memory address affected by the at least one defective memory hardware location and a corresponding replacement hardware location address, and switching (170), by the one or more hardware address determination circuitries, to adapting the mapping by shifting the mapping when a condition is met.

Another example (e.g., example 48) relates to a previous example (e.g., example 47) or to any other example, further comprising that the condition is based on an availability of replacement hardware location addresses.

Another example (e.g., example 49) relates to a previous example (e.g., one of the examples 47 or 48) or to any other example, further comprising that the condition is based on a time schedule.

Another example (e.g., example 50) relates to a previous example (e.g., one of the examples 47 to 49) or to any other example, further comprising that the condition is based on a load of the computer system.

Another example (e.g., example 51) relates to a previous example (e.g., one of the examples 45 to 50) or to any other example, further comprising that the method comprises copying (175) a content of memory from a hardware location address associated with a physical memory address prior to shifting the mapping to a hardware location address associated with the physical memory address after shifting the mapping.

Another example (e.g., example 52) relates to a previous example (e.g., one of the examples 41 to 51) or to any other example, further comprising that the method comprises adapting (160), by the one or more hardware address determination circuitries, the mapping based on a data structure of one or more mappings between a physical memory address affected by the at least one defective memory hardware location and a corresponding replacement hardware location address.

Another example (e.g., example 53) relates to a previous example (e.g., example 52) or to any other example, further comprising that a plurality of hardware address determination circuitries are associated with two or more hierarchy levels, wherein a hardware address determination circuitry at a top hierarchy adapts the mapping based on the data structure of mappings.

Another example (e.g., example 54) relates to a previous example (e.g., one of the examples 41 to 53) or to any other example, further comprising that the method comprises determining (130) a mapping between a physical memory address and a hardware location address of corresponding memory (102) connected to the computer system via a bus for attaching peripheral methods to the computer system.

Another example (e.g., example 55) relates to a previous example (e.g., example 54) or to any other example, further comprising that the bus is a peripheral component interconnect express bus.

Another example (e.g., example 56) relates to a previous example (e.g., one of the examples 41 to 55) or to any other example, further comprising that the method comprises managing (110), by a microcontroller, the information identifying at least one defective memory hardware location stored in the memory circuitry.

Another example (e.g., example 57) relates to a previous example (e.g., example 56) or to any other example, further comprising that the method comprises instructing (145), by a microcontroller, the one or more hardware address determination circuitries to adapt the mapping.

Another example (e.g., example 58) relates to a previous example (e.g., one of the examples 41 to 57) or to any other example, further comprising that the information identifying at least one defective memory hardware location is stored in non-volatile memory (12).

Another example (e.g., example 59) relates to a computer system (100) being configured to perform the method (10) according to one of the examples 41 to 58.

Another example (e.g., example 60) relates to a previous example (e.g., example 59) or to any other example, further comprising that the computer system further comprises the memory (101, 102).

Another example (e.g., example 61) relates to a computer program having a program code for performing the method of one of the examples 41 to 60, when the computer program is executed on a computer system comprising one or more hardware address determination circuitries.

Another example (e.g., example 62) relates to a non-transitory, computer-readable medium comprising a program code that, when the program code is executed on a processor, a computer, or a programmable hardware component, causes the processor, computer, or programmable hardware component to perform the method of one of the examples 41 to 60.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product. Such instructions can cause a computing system or one or more processing units, capable of executing computer-executable instructions, to perform any of the disclosed methods. As used herein, the term “computer” refers to any computing system or device described or mentioned herein. Thus, the term “computer-executable instruction” refers to instructions that can be executed by any computing system or device described or mentioned herein.

The computer-executable instructions can be part of, for example, an operating system of the computing system, an application stored locally on the computing system, or a remote application accessible to the computing system (e.g., via a web browser). Any of the methods described herein can be performed by computer-executable instructions on a single computing system, or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C#, Java, Perl, Python, JavaScript, Adobe Flash, C#, assembly language, or any other programming language. Likewise, the disclosed technologies are not limited to any particular computer system or type of hardware.

Furthermore, any of the software-based examples (comprising, for example, computer-executable instructions for causing a computer to perform any of the disclosed methods) can be uploaded, downloaded, or remotely accessed through suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

The disclosed methods, apparatuses, and systems are not to be construed as limiting in any way. Instead, the present disclosure is directed toward all novel and nonobvious features and aspects of the various disclosed examples, alone and in various combinations and subcombinations with one another. The disclosed methods, apparatuses, and systems are not limited to any specific aspect or feature or combination thereof, nor do the disclosed examples require that any one or more specific advantages be present, or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

The aspects and features described in relation to a particular one of the previous examples may also be combined with one or more of the further examples to replace an identical or similar feature of that further example, or to additionally introduce the features into the further example.

Examples may further be or relate to a (computer) program including program code to execute one or more of the above methods when the program is executed on a computer, processor, or other programmable hardware component.

Thus, steps, operations or processes of different ones of the methods described above may also be executed by programmed computers, processors, or other programmable hardware components.

Examples may also cover program storage devices, such as digital data storage media, which are machine-, processor-or computer-readable and encode and/or contain machine-executable, processor-executable, or computer-executable programs and instructions.

Program storage devices may include or be digital storage devices, magnetic storage media such as magnetic disks and magnetic tapes, hard disk drives, or optically readable digital data storage media, for example.

Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs), or system-on-a-chip (SoCs) systems programmed to execute the steps of the methods described above.

It is further understood that the disclosure of several steps, processes, operations, or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps, -functions, -processes, or -operations.

If some aspects have been described in relation to a device or system, these aspects should also be understood as a description of the corresponding method. For example, a block, device, or functional aspect of the device or system may correspond to a feature, such as a method step of the corresponding method. Accordingly, aspects described in relation to a method shall also be understood as a description of a corresponding block, a corresponding element, a property, or a functional feature of a corresponding device or a corresponding system.

The following claims are hereby incorporated in the detailed description, wherein each claim may stand on its own as a separate example. It should also be noted that although a dependent claim in the claims refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent upon that other independent claim.

What is claimed is:

1. An apparatus for a computer system, comprising:
memory circuitry for storing information identifying at least one defective memory hardware location; and
one or more hardware address determination circuitries configured to determine a mapping between a physical memory address and a hardware location address of corresponding memory,
wherein the one or more hardware address determination circuitries are configured to adapt the mapping at run-time upon obtaining updated information identifying at least one defective memory hardware location.

2. The apparatus according to claim 1, wherein the apparatus comprises circuitry configured to report an amount of available memory based on the information identifying the at least one defective memory hardware location.

3. The apparatus according to claim 1, wherein the one or more hardware address determination circuitries are configured to determine a reduced or minimal set of physical hardware addresses affected by the at least one defective memory hardware location, and to adapt the mapping based on the reduced or minimal set of physical hardware addresses.

4. The apparatus according to claim 1, wherein the one or more hardware address determination circuitries are configured to determine a mapping between a physical memory address and a hardware location address of corresponding memory using a hashing function, thereby performing memory striping across a plurality of memory circuitries.

5. The apparatus according to claim 1, wherein the one or more hardware address determination circuitries are configured to adapt the mapping by shifting the mapping between a physical memory address and a hardware location address based on a hardware location and number of a set of physical hardware addresses affected by the at least one defective memory hardware location.

6. The apparatus according to claim 5, wherein, if the hardware location addresses are striped across a plurality of memory circuitries, shifting is performed for a memory circuitry based on a hardware location and number of a set of physical hardware addresses affected by the at least one defective memory hardware location of that memory circuitry.

7. The apparatus according to claim 5, wherein the one or more hardware address determination circuitries are configured to initially adapt the mapping based on a data structure of one or more mappings between a physical memory address affected by the at least one defective memory hardware location and a corresponding replacement hardware location address, and to switch to adapting the mapping by shifting the mapping when a condition is met.

8. The apparatus according to claim 7, wherein the condition is based on an availability of replacement hardware location addresses.

9. The apparatus according to claim 7, wherein the condition is based on a time schedule.

10. The apparatus according to claim 7, wherein the condition is based on a load of the computer system.

11. The apparatus according to claim 5, wherein the one or more hardware address determination circuitries are configured to copy a content of memory from a hardware location address associated with a physical memory address prior to shifting the mapping to a hardware location address associated with the physical memory address after shifting the mapping.

12. The apparatus according to claim 1, wherein the one or more hardware address determination circuitries are configured to adapt the mapping based on a data structure of one or more mappings between a physical memory address affected by the at least one defective memory hardware location and a corresponding replacement hardware location address.

13. The apparatus according to claim 12, wherein the apparatus comprises a plurality of hardware address determination circuitries associated with two or more hierarchy levels, wherein a hardware address determination circuitry at a top hierarchy level is configured to adapt the mapping based on the data structure of mappings.

14. The apparatus according to claim 1, wherein the one or more hardware address determination circuitries are configured to determine a mapping between a physical memory address and a hardware location address of corresponding memory connected to the computer system via a bus for attaching peripheral devices to the computer system.

15. The apparatus according to claim 14, wherein the bus is a peripheral component interconnect express bus.

16. The apparatus according to claim 1, wherein the apparatus comprises microcontroller circuitry configured to manage the information identifying at least one defective memory hardware location stored in the memory circuitry.

17. The apparatus according to claim 16, wherein the microcontroller circuitry is configured to instruct the one or more hardware address determination circuitries to adapt the mapping.

18. A computer system comprising the apparatus according to claim 1.

19. A method for a computer system, comprising:
storing information identifying at least one defective memory hardware location; and
determining, by one or more hardware address determination circuitries, a mapping between a physical memory address and a hardware location address of corresponding memory,
adapting, by the one or more hardware address determination circuitries, the mapping at run-time upon obtaining updated information identifying at least one defective memory hardware location.

20. The method according to claim 19, wherein the method comprises reporting an amount of available memory based on the information identifying the at least one defective memory hardware location.
